(19) United States
(12) Patent Application Publication
(10) Pub. No.: US 2008/0112760 A1
(43) Pub. Date: May 15, 2008

(54) Method of storage of sequestered greenhouse gasses in deep underground reservoirs

(76) Inventor: Harry B. Curlett, Cody, WY (US)

Correspondence Address: WINSTEAD PC, P.O. BOX 50784, DALLAS, TX, 75201, US

(21) Appl. No.: 11/897,861

(22) Filed: Aug. 31, 2007

Related U.S. Application Data
(60) Provisional application No. 60/841,875, filed on Sep. 1, 2006.
(60) Provisional application No. 60/930,403, filed on May 16, 2007.

(51) Int. Cl. B65G 5/00

(52) U.S. Cl. 405/55; 175/50

(57) ABSTRACT

A system and method for storage of Greenhouse Gasses, in particular CO2 gasses, in an underground reservoir of rock at the shallowest depth necessary to achieve a combination of temperature and pressure sufficient to ensure that the reservoir is hydraulically sealed and isolated. Particle Jet Drilling is utilized to afford an economical process of drilling the necessary deep well bores to reach the deep rock formations. The underground reservoirs are formed through hydraulic dilation of existing joints in the rock formations.

### CROSS-REFERENCE TO RELATED APPLICATIONS

This patent application claims priority from and incorporates by reference the entire disclosure of U.S. Provisional Patent Application No. 60/841,875, filed on Sep. 1, 2006. This patent application incorporates by reference the entire disclosures of U.S. Provisional Patent Application No. 60/582,626, filed on Jun. 23, 2004, U.S. Provisional Patent Application No. 60/650,667, filed on Feb. 7, 2005, and U.S. patent application Ser. No. 10/581,648, filed on Jun. 1, 2006. This patent application claims priority from and incorporates by reference the entire disclosure of U.S. Provisional Patent Application 60/930,403, filed on May 16, 2007.

### BACKGROUND OF THE INVENTION

1. Field of the Invention

The present invention relates to the storage of sequestered Greenhouse Gas (“GHG”) and, more particularly, but not by way of limitation, to the development of Deep Underground Reservoirs in crystalline rock utilizing bore hole generation (drilling) with Particle Jet Drilling Methods.

2. History of Related Art

At present, a majority or the world's energy demands is supplied primarily by fossil fuels such as coal, oil, and gas. One reason is that no economically viable alternative energy sources are currently available. Unfortunately the use of fossil fuels appears to cause serious environmental problems due to the production of certain GHG and other deleterious agents. The atmosphere may be warming because of the “greenhouse effect,” which may be caused by large quantities of carbon dioxide being released to the atmosphere as a result of burning fossil fuels. The long-term consequences of the greenhouse effect are currently a matter of debate; they may include melting of the polar ice caps, with a resultant increase in sea level and flooding of coastal cities, and increased desertification of the planet. Evidence pointing toward greenhouse effect warming includes increases in the carbon dioxide content of the atmosphere over the past century and weather records that seem to indicate an upward trend in atmospheric temperatures. These facts point to the need to consider mitigating action now, before we are overtaken by our own emissions.

Several of these points are set forth and described more fully in the scientific American article entitled, “A Plan To Keep Carbide In Check” published on or about August 2006 for the September 2006 issue. Within that article by Robert H. Socolow and Stephen W. Pacala, the effect of greenhouse gasses is addressed and the importance of obtaining a solution to the steady increase in greenhouse gasses as charted between the years 1956 and 2006 is explained. Such studies and papers are wide spread in the year of 2006. Indeed, a book on the greenhouse effect entitled, “An Inconvenient Truth . . . The Planetary Emergency of Global Warming and What We Can Do About It” by Al Gore, the former Vice President of United States, also voices such concerns and provides other data relative to the seriousness of the rising CO₂ levels within the Earth's atmosphere.

One idea to mitigate the greenhouse effect is to permanently store CO₂ underground in such locations as depleted oil and gas fields. Such a method is disclosed in U.S. Pat. No. 7,043,920, which discloses a method of collecting CO₂ from combustion gasses and compressing the CO₂ to deliver the gasses to terrestrial formations; such formations include oceans, deep aquifers, and porous geological formations such as depleted or partially depleted oil and gas formations, salt caverns, sulfur caverns, and sulfur domes for storage.

Also disclosing the idea of storing CO₂ in underground reservoirs is U.S. Pat. No. 6,668,554 ('554). '554 discloses that CO₂ may be stored in deep rock formations to combat the problem of global warming.

Another example is seen in U.S. Pat. No. 6,609,895 ('895), which discloses a method of pumping dense phase gasses, specifically CO₂ into an oil or gas reservoir. '895 also discloses pumping GHG into reservoirs or underwater for storage.

Another example is seen in U.S. Pat. No. 6,598,407, which discloses a method of converting CO₂ into a stream of liquid CO₂, CO₂ hydrate, and water that has density greater than that of sea water at depths in the range of at least 700-1500 meters. Upon release at ocean depths in the range of 700-1500 meters the mixture sinks to the bottom and becomes more stable and reduces deleterious impacts of free CO₂ gas in ocean water. The method allows for the efficient and permanent storage of CO₂.

A related idea is disclosed in U.S. Pat. No. 5,685,362 ('362), which discloses a method of power production involving pumping water into a Hot Dry Rock reservoir. During off-peak periods of power usage, '362 discloses that water may be stored in the reservoir for later use, taking advantage of the reservoir's elasticity to generate power from this water that may then be re-used.

In a Science Beat article by Paul Preuss from Feb. 1, 2001 it was reported that the US Department of Energy has begun a program known as GEO-SEQ that is focused on sequestering CO₂ gasses in depleted gas fields, unmineable coal beds, and deep brine-filled formations.

In a News in Science article entitled “Forcing CO₂ underground ‘unsustainable’”, by Anna Salleh from Jun. 5, 2001, it was reported that, in Australia, Greenpeace is investigating the possibility of underground storage of Greenhouse Gasses, which has the potential to make a substantial difference in global greenhouse emissions. However, he also states that it is a costly option with dubious long term benefits.

In an article published by M2 Communications on Sep. 17, 2002 made available on CO2e.com it was reported that the United Kingdom, a new investigation into the reduction of greenhouse gasses includes the study of carbon dioxide capture and storage. The method involves storing the gasses in depleted oil and gas wells in the North Sea. The study is focused on developing the technology to carry out such an operation, the legal implications of such an operation, and the economic cost. Energy Minister Brian Wilson also states that pumping CO₂ into oil fields can actually increase the amount of recoverable oil.

A grant to the Imperial College London by the Engineering Physics and Sciences Research Council entitled “JEFI: The UK carbon capture and storage consortium” discloses research on drilling special boreholes to a depth of 1 km or more to store CO₂ in porous reservoir rock, such as sandstone, with a sealing layer of less permeable rock on top. Alternately, storing CO₂ in off-shore aquifers containing brine is also discussed. The grantees intend to study the feasibility of storing CO₂ in these aquifers, the potential for leaks to occur, and the effect on ocean ecosystems.

Another grant to the University of Nottingham by the Engineering Physics and Sciences Research Council entitled “Developing Effective Adsorbant Technology for the Capture of CO₂” discloses research aimed at finding more economical ways of capturing CO₂ gasses from power plant production. The University is currently pursuing the idea of using a solid made of stable polymers with porous structures to trap the CO₂ gasses so that they may be captured and later stored. The polymers will be formed using a technique known as ‘nanocasting’ to give the polymers a tailored pore structure.

Currently, sedimentary formations are being extensively researched as possible locations for the storage of GHG, as they are known to naturally exhibit the porosity and permeability that is requisite of a storage reservoir. While much is known about sedimentary formations, most of that knowledge pertains to the production and capture of oil, gas, or water that may be contained within the formations. The permanent storage of GHG requires not only porosity and permeability, but also requires that the formation may be effectively sealed so as to prevent any leakage of the CO₂ or GHG from the formation. This seal is essential; any leakage would negate the benefits of pursuing such an endeavor.

Rock formations are typically considered to be brittle, meaning that they react in a brittle fracture mode when stressed mechanically or hydraulically. Sedimentary formations are no exception and are considered brittle formations, and therefore they are susceptible to tectonic stresses that mechanically generate faulting and fracturing, both in the past and into the future. These brittle failure aspects of sedimentary formations provide the potential to generate leaks and seeping of GHG out of the sedimentary formation systems. This means that finding a sedimentary formation that has the requisite porosity, permeability and a leak tight sealing system is very difficult; few sites have all the necessary aspects to be considered as viable reservoirs for permanent CO₂ and GHG storage. Further, due to the brittle nature of these sedimentary formations, any future tectonic forces, subsidence forces resulting from removal of oil and gas, or fracturing resulting from injection of fluids may detrimentally affect the reservoir conditions, and the reservoir sealing mechanism in particular.

It is one goal of the present invention to provide an underground storage reservoir that can store large quantities of CO₂ without the potential drawbacks of sedimentary rock formations. The reservoir should be located at the shallowest depth necessary to achieve a combination of temperature and pressure sufficient to ensure that the reservoir is hydraulically sealed.

### SUMMARY OF THE INVENTION

The present invention relates to a system and method of storing GHG in underground, artificially created reservoirs capable of long term storage without risk of leakage. More particularly, one embodiment of the present invention relates to the use of non-rotary mechanical drilling methods, such as particle jet drilling, to create deep bore holes that provide improved access crystalline rock formations capable of being hydraulically fractured for creation of an artificial reservoir capable of storing large amounts of CO₂. Preferably, the rock formation is at the shallowest depth necessary to achieve a combination of temperature and pressure sufficient to ensure sufficient rock plasticity so as to be able to contain the reservoir fluid in a sealed hydraulic reservoir. Further, such reservoir conditions will provide supercritical fluid conditions for GHG such as CO₂, resulting in an ability to inject, diffuse, and store large quantities of GHG.

Permeable geologic strata are found in numerous site-specific locations around the globe, and are one possibility of locations in which to store CO₂ gasses. The underground reservoir specifications for CO₂ sequestration have been determined, and there are generally very few permeable geologic locations that meet the specifications for permanent storage. This is because not only does there have to be certain porosity and permeability characteristics, but there has to be a permanent seal around the reservoir to ensure the GHG do not leak to the surface again and escape into the atmosphere. Various formations and locations are currently being evaluated. The most likely suitable subsurface formations, sedimentary formations, will have regional characteristics that make predicting their specific suitability for storage very difficult at best. The results of storing GHG in these formations may not be known for years after the expense to inject the GHG, and this poses significant risks not only from reservoir seal leaks, but also from the fact that even once a suitable formation has been located and tested, its proximity to the source of GHG capture may be such that it is uneconomical to transport the GHG to the storage site.

One embodiment of the present invention provides a location for CO₂ storage that is available in most all areas of the world in deep crystalline rock in which leak proof artificial reservoirs can be generated. Such formations are typically Precambrian rocks that are found almost everywhere around the globe, and are generally located at depths greater than sedimentary geologic strata. These deep artificial reservoirs in crystalline rock are beneficial for several reasons. First, these deep seated crystalline rock formations are relatively plastic due to the heating effects and the existence of formation joints that may be dilated to accept large quantities of CO₂ without concern of leakage of the CO₂ to the earth's surface. Reservoir formation through the application of artificial hydraulic pressure in crystalline rock formations has been demonstrated in various Hot Dry Rock experimental operations. Another benefit of very deep wells includes the existence of super critical fluid conditions for GHG, thereby effectively allowing low viscosity diffusivity into the created reservoir.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a diagrammatic view of an example system for the underground storage of CO₂ in a crystalline rock formation;

FIG. 2 is a diagrammatic view of an example system for the underground storage of CO₂ in a crystalline rock formation with bridge plug and cap in place.

FIG. 3 is a diagrammatic schematic illustration of the drilling of a well bore within a plurality of earthen formations; and

FIG. 4 a flow diagram of one embodiment of the principles of the present invention.

FIG. 5a is an isometric view of the particle jet drilling head assembly.

FIG. 5b is an exploded view of the particle jet drilling head assembly of FIG. 6a.

FIG. 5c is an axially sectioned view of the particle jet drilling head assembly of FIG. 5a.

FIG. 5d is a top view of particle jet drilling head assembly of FIG. 6a.

FIG. 5e is a front view of the particle jet drilling head assembly of FIG. 6a.

FIG. 5f is an end view of the particle jet drilling head assembly of FIG. 6a.

FIG. 6a is a cross sectional view of the lower end of the well bore and the particle jet drilling head assembly, providing a partial illustration of the slurry flow through the drill pipe and head and through the near head well bore annulus region.

FIG. 6b illustrates the expected result of the action of the use of the side jets while drilling in a well bore.

FIG. 6c illustrates the action of employing the side jets for conditioning the well bore.

FIG. 6d illustrates part of the cutting action of the conical cutting jet flow issuing from the particle jet drilling head.

### DETAILED DESCRIPTION

Various embodiment(s) of the invention will now be described more fully with reference to the accompanying Drawings. The invention may, however, be embodied in many different forms and should not be construed as limited to the embodiment(s) set forth herein.

Drilling deep well bores has proven prohibitively expensive when using rotary-mechanical drilling systems. Therefore, applicant proposes that these deep reservoir systems must be accessed by non-rotary-mechanical drilling methods if they are to be economically viable. One such method of economically generating the deep storage reservoirs in crystalline rock is to drill the well bore with Particle Jet Drilling methods described more fully in the above referenced '648 application. The novelty of the inventive method lies in two areas. The first and primary area of novelty is storing GHG in hydraulically isolated reservoirs, a secure container that is not susceptible to brittle fracture to the same degree as sedimentary formations. This condition requires that the rock formations are located at the shallowest depth necessary to achieve a combination of temperature and pressure sufficient to ensure rock plasticity necessary to create a sealed hydraulic reservoir. By way of example, such representative temperatures could be about 250° C. for Calcite formations, 300° C. for Quartz formations, and 500° C. for Feldspar formations. At these elevated temperatures and pressures, the crystalline rock formations have a threshold plastic nature that allows a hydraulically sealed reservoir to be formed. At lower temperatures and pressures, the rock formations would fracture in an unpredictable manner with the risk of GHG leaking over time from the reservoir to the surface. The second area of novelty involves the method by which the reservoir well is created. Creating the reservoir at the requisite temperatures usually requires that the well bore be much deeper than can be economically drilled with conventional means. The most economical drilling methods are non-conventional rotary mechanical drilling methods such as Particle Jet Drilling.

The benefit of this inventive method is that the use of non-rotary mechanical drilling methods, Particle Jet Drilling in particular, provide an economical manner to drill deep well bores for the purpose of permanently storing GHG. The economical nature of non-rotary mechanical drilling allows for reservoirs to be created virtually anywhere. Specifically, it allows for reservoirs to be situated near the source of capture of the GHG, which makes the transport of gasses to the reservoir much more economical. Further, the deep reservoirs are able to hold vast quantities of GHG without risk of leakage to the surface due to the extensive overburden and the relatively plastic nature of the surrounding rock. Furthermore, the in situ formation temperatures that exist in deep reservoirs aid in the creation of supercritical fluid conditions are absent in some of the shallower sedimentary formations. CO₂ reaches supercritical state at temperatures of 31.1° C. and 1059 PSI. This equates to a potential depth of 2,650 feet. As a result, relatively shallow sedimentary formations create conditions for, CO₂ in particular, to reach a supercritical state. This is a phase change point, and additional temperatures and pressures continue to generate physical effects on the CO₂ depending on the ratio of temperature to pressure.

In contrast to sedimentary rock formations, Precambrian and Haden crystalline rock formations, which extend to the mantle of the earth, generally do not have the same relative natural porosity or permeability as the upper sedimentary rock formations they underlie. Sedimentary formations have been extensively explored and studied due to the constant search for oil and gas, and there is a great deal of understanding of these sedimentary formations. Conversely, relatively little drilling is conducted below these sedimentary formations and therefore there is much less known about crystalline rock formations. The fact that rotary mechanical drilling costs increase exponentially as depth increases further adds to the comparatively less information available about drilling crystalline rock formations. Additionally, crystalline rock formations are extremely hard and abrasive, which further increases the cost of drilling these types of rock formations with rotary mechanical drilling means.

Crystalline rock formations are also subject to brittle failure modes when stressed. However, if the granite rock that comprises the crystalline rock formation is in a heated state, a modification to the failure mode occurs and shifts away from brittle fracture and towards that of plastic failure. Studies conducted to understand the ability to mine heat from crystalline rock have determined that crystalline rock has naturally formed joints, generated as the earth's crust cooled, that typically have been chemically cemented over time. These joints can be dilated under hydraulic stress to form an integrated matrix of interconnected, dilated joints. This newly formed matrix of dilated joints creates artificial porosity and permeability sufficient to allow fluids to pass into and through the reservoir, enabling the reservoir to transfer heat to the passing fluids, thus acting as a heat exchanger. Further, it has been determined that crystalline rock under sufficient temperature and pressure transitions to a stress state failure mode that shifts progressively with increasing temperature from the brittle failure mode towards plastic failure mode. This is significant because under these heated conditions, an effective hydraulic container can be generated that will have the properties of porosity, permeability, and an effective reservoir volume seal. Again, by way of example, such representative temperatures could be in the range of 250° C. for Calcite formations, 300° C. for Quartz formations, and 500° C. for Feldspar formations. Additionally, under these conditions, GHG and CO₂ can be injected into the artificial reservoir under super critical fluid conditions, whereby the CO₂ has the density of a liquid but the viscosity of a gas like fluid. The combination of depth (hydrostatic head) and temperature generates super critical fluid conditions for the injected GHG or CO₂, which allows injection of the gasses at minimal pressures further provides maximum diffusivity in the reservoir system.

Utilization of non-rotary mechanical drilling means, such as Particle Jet Drilling, high power pulse laser drilling, thermal spallation drilling techniques, or a combination thereof have the potential to linearize the cost of drilling with depth even into the hard abrasive crystalline rock formations at great depth. The use of non-rotary mechanical drilling means allows for cost effective drilling to the depths necessary to reach crystalline rock formations with the necessary characteristics to form storage reservoirs. These characteristics include porosity, permeability, and sufficient temperature and pressure to form a hydraulic seal. Given that the crystalline rocks necessary to form these permanent sequestration repository reservoirs are literally found everywhere beneath the surface, the ability to provide GHG and CO₂ sequestration reservoirs at locations near the source of where the gasses are captured provides a significant advantage over using sedimentary formations, which may require significant pipeline construction to transport the gasses to the reservoir.

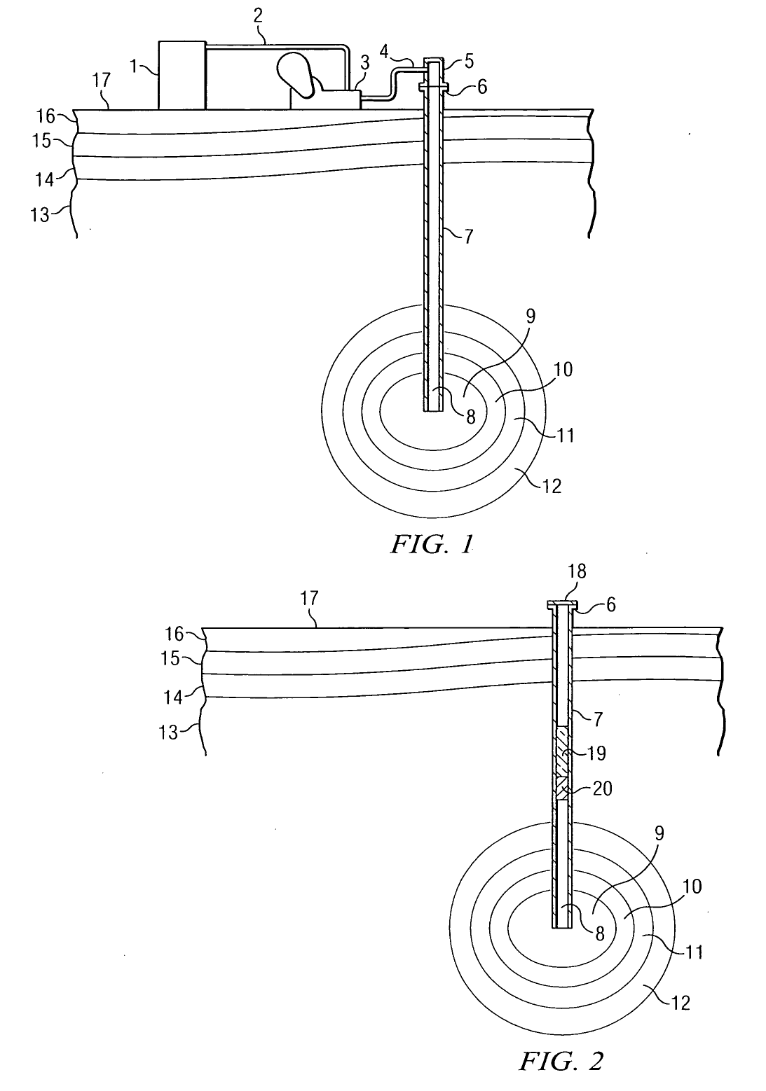

Referring first to FIG. 1, a general arrangement of the invention is shown. There is a sequence of subsurface formations that are roughly classified as sedimentary and crystalline type rock formations. Generally the sedimentary formations are closer to the surface 17 and generally overlay the deep crystalline formations 13. Sedimentary rock formations are composed of sub groups of layers of such rock formations as shale 16, sandstone 15, and limestone 14 and their various intermediate types.

Cased well bore 7 is located in close proximity to GHG capture means 1. Cased well bore 7 is drilled from the surface 17 utilizing Particle Jet Drilling means through sedimentary formations 16, 15 and 14 into Precambrian crystalline formation 13 to the shallowest depth necessary to achieve a combination of temperature and pressure sufficient to provide a transition from an unacceptable level of a brittle failure mode to an acceptable plastic failure mode generally believed to be a temperature of at least of 250° C. The well bore 7 is cased and a reservoir 9 formed through any means that would provide the porosity and permeability necessary for GHG storage. Such means to generate the artificial reservoir 9 could encompass but not be limited to the injection of a fluid to hydraulically dilate the existing joints within the formation such as is used in Hot Dry Rock reservoir generation methods to a high energy pulse stress fracturing forces generated from underground conventional or thermo-nuclear explosions. Once the artificial reservoir 9 has been generated, the reservoir formation fluid can be removed through reducing the well head and/or hydrostatic pressure and allowing the elastic stress stored in the artificial reservoir and generated in the reservoir formation process to cause the working fluid to be expelled from the well bore. Further, by reducing the hydrostatic pressure, the working fluid can flash to a low density gaseous form due to the high reservoir temperature and escape from the well bore. An injection head 5 is installed on the well head 6 attached to well bore casing 7.

A means of capturing a GHG such as CO₂ is represented by 1. Production of GHG for capture could be, for example, from a process such as the burning of coal for electrical power generation, or the production of hydrogen through electrolysis which gives off CO₂. The CO₂ is collected and piped through pipe line 2 to pump 3, which pressurizes the CO₂ to pressure levels necessary to inject the CO₂ into well head injector port 5 and through well head 6 into and through cased well bore 7 into crystalline reservoir 9 through distal end 8 of well bore casing 7. The GHG will be under super critical fluid conditions somewhere between the well head 6 and distal end 8 of well bore 7 depending on the type of fluid, the depth of the reservoir 9, the earthen formation's temperature gradient, and crystalline formation 13 temperature.

As the GHG is injected into reservoir 9, the reservoir will continue to grow in stages to a progressively increased volume over time. This is due to diffusion of the GHG and expansion that occurs from temperature absorption and the injection of additional volumes of GHG fluids as indicated by reservoir extended volumes 10, 11 and 12.

FIG. 2 illustrates the completion of the sequestration reservoir once sufficient GHG have been stored in the respective reservoirs 9, 10, 11 and 12. Upon completion, the well is plugged with any combination of a drillable, permanent bridge plug 20 and a column of cement 19 placed on top of the permanent bridge plug 20. The well head is capped with well head cap 18. This system of completion provides the ability to permanently and securely store the GHG in the sequestration reservoir while also providing the ability to re-enter the well bore and drill out the cement and bridge plug to access the GHG if a future use for the GHG is determined. Such future use could be the chemical processing of the GHG to a useable end product, such as the Sabatier process of combining CO₂ and H2 with a Nickle catalyst at elevated pressures and temperatures to produce methane and water, or utilizing the reservoir environment to generate chemical processes.

The following discussion is presented for purposes of specificity when describing the bore hole generation techniques set forth as shown herein. The bore hole is generated utilizing a PJD method of drilling the well. It is common knowledge that drilling large diameter deep well bores in Precambrian Rock is prohibitively expensive with common rotary mechanical earthen formation drilling practices. The slow rate of penetration and high cost associated with the rotary mechanical drilling of Precambrian rock have been the prohibitive causes of drilling to such depths. The use of Particle Jet Drilling (PJD) techniques and methods provides a means to increase the rate of penetration and decrease the cost in drilling all formations, particularly in crystalline rock formations. This increase in efficiency allows for the creation of the deep well bores that are necessary in creating the underground storage reservoirs.

The use of PJD methods for reducing the cost of drilling well bores terminating in Precambrian or Hadean formations is fundamental to the widespread development of the HDR potential and can be seen as essential for the widespread development of GHG sequestration. Specifically, PJD provides a means to economically drill large diameter, very deep injection and production well bores for HDR production purposes. The specific well bore geometry, used in conjunction with PJD techniques, is unique to producing the environment to operate the PJD techniques at optimal levels for rate of penetration performance purposes.

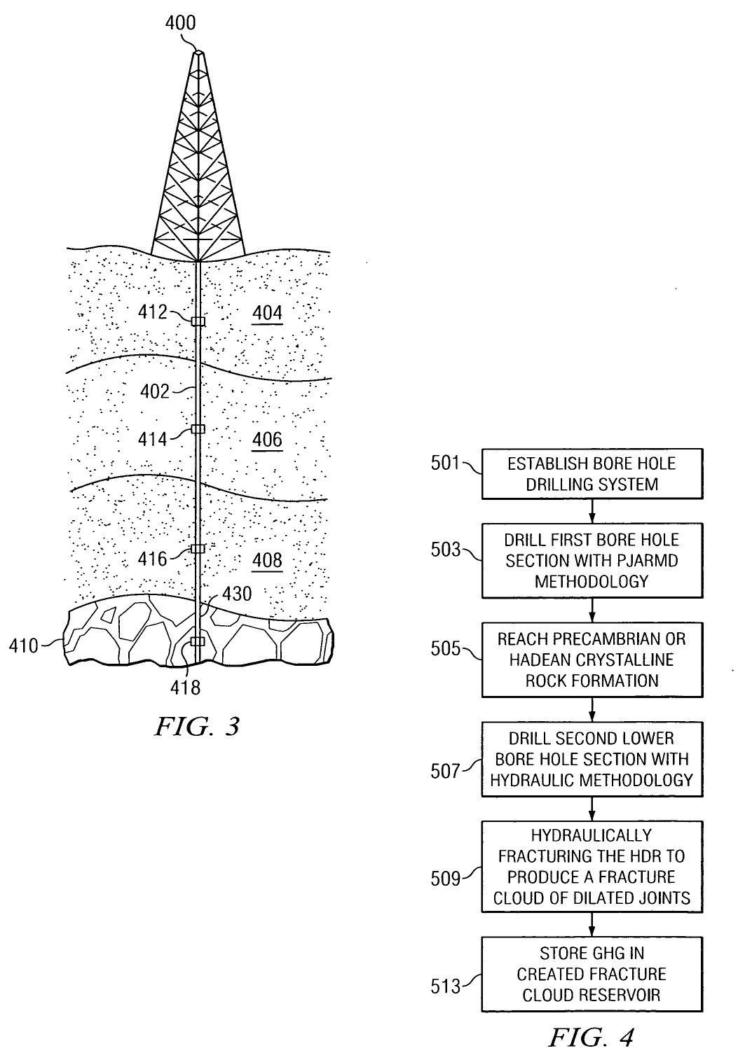

Referring now to FIG. 3, there is shown a diagrammatic schematic illustration of the drilling of a well bore within a plurality of earthen formations. At the wellhead 400 represented by the diagrammatic illustration of a derrick, a first earthen formation 404 is penetrated by well bore 402. The type of drill bit utilized in this particular formation may be a mechanical drill bit conventional for shallow wells and/or Particle Jet Assisted Rotary Mechanical Drilling (PJARMD) referenced herein. Diagrammatically represented in lower earthen formation 406 is a drill bit 414 which may be the same as and/or similar to the drill bit 412 but may vary in accordance with the principles of the present invention depending on the type of earthen structure found in earthen section 406. Likewise, earthen section 408 is a continuation of the well bore 402 and illustrates, diagrammatically, a drill bit 416 which may be of a different methodology in accordance with the principles of the present invention, depending on the type of structure engaged in earthen formation 408. Finally, earthen formation 410 is diagrammatically represented as a Precambrian and/or Hadean crystalline rock wherein the bore hole section 430 is shown penetrated by a hydraulic drilling methodology found in the drilling tool 418 which may incorporate PJD in accordance with the principles of the present invention for penetrating the Precambrian or Hadean crystalline rock formation for accessing and establishing a site within the bore hole for subsequent hydraulic fracturing and the charging and discharging described above in accordance with the principles of the present invention.

Referring now to FIG. 4 there is shown a flow diagram of one embodiment of the principles of the present invention. In this particular flow diagram, the methodology described above is clearly set forth and shown wherein step 501 includes the establishment of a bore hole drilling system in accordance with the principles of the present invention. Step 503 illustrates the drilling of a first bore hole section with a PJARMD methodology. This methodology may change depending upon the particular type of the earthen formation as illustrated in FIG. 4.

Still referring to FIG. 4, the step 505 represents the bore hole reaching the Precambrian or Hadean crystalline rock formation where the type of drill bit being used may vary in accordance with the principles of the present invention. Step 507 illustrates drilling a second, lower bore hole section through the Precambrian or Hadean crystalline rock formation with hydraulic drilling methodology. Step 509 illustrates the hydraulic fracturing of the HDR to produce a fracture cloud of dilated joints. Step 513 illustrates storing GHG in the fracture cloud.

It should be particularly noted that FIGS. 3 and 4 have been taken, in the name, from above-referenced, prior filed U.S. patent application Ser. No. 10/581,648 filed Jun. 1, 2006. In the 648 application, FIGS. 3 and 4 collate to FIGS. 7 and 8 with certain modifications made therein more specifically refer to the technology of the parent application as it is used in the present application.

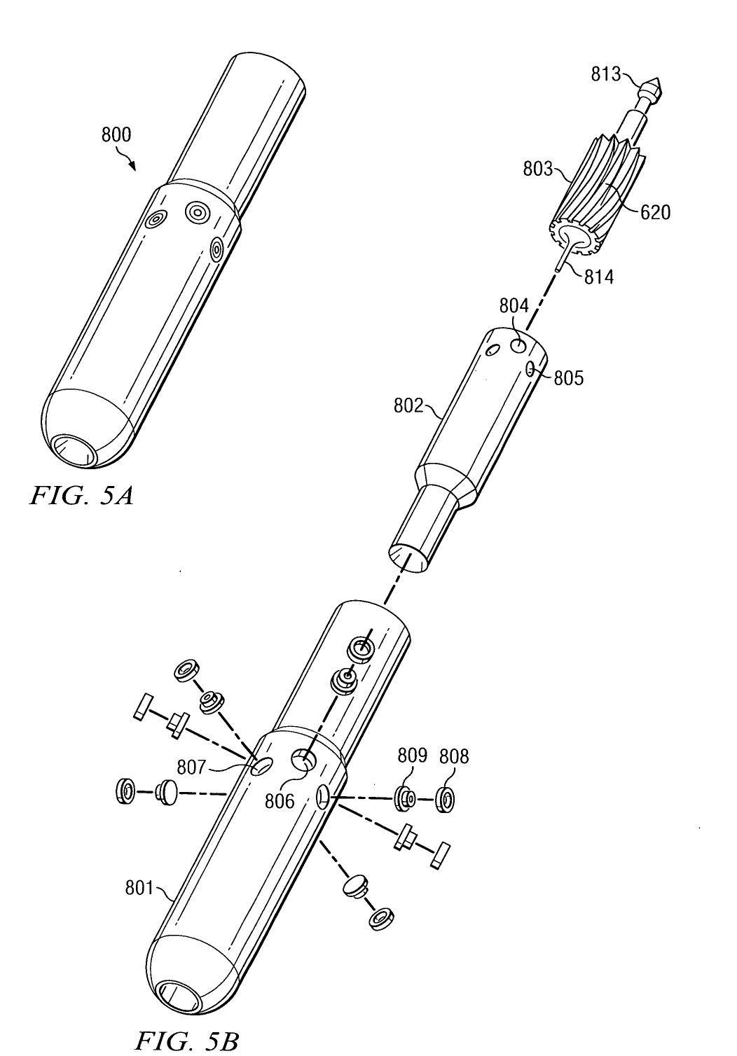

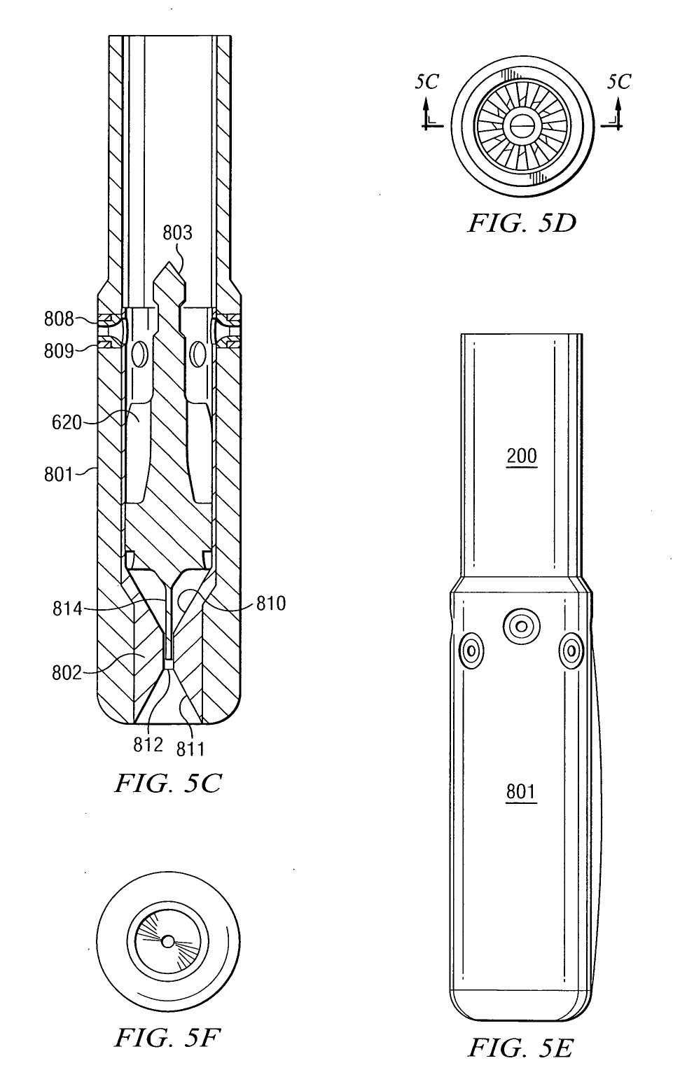

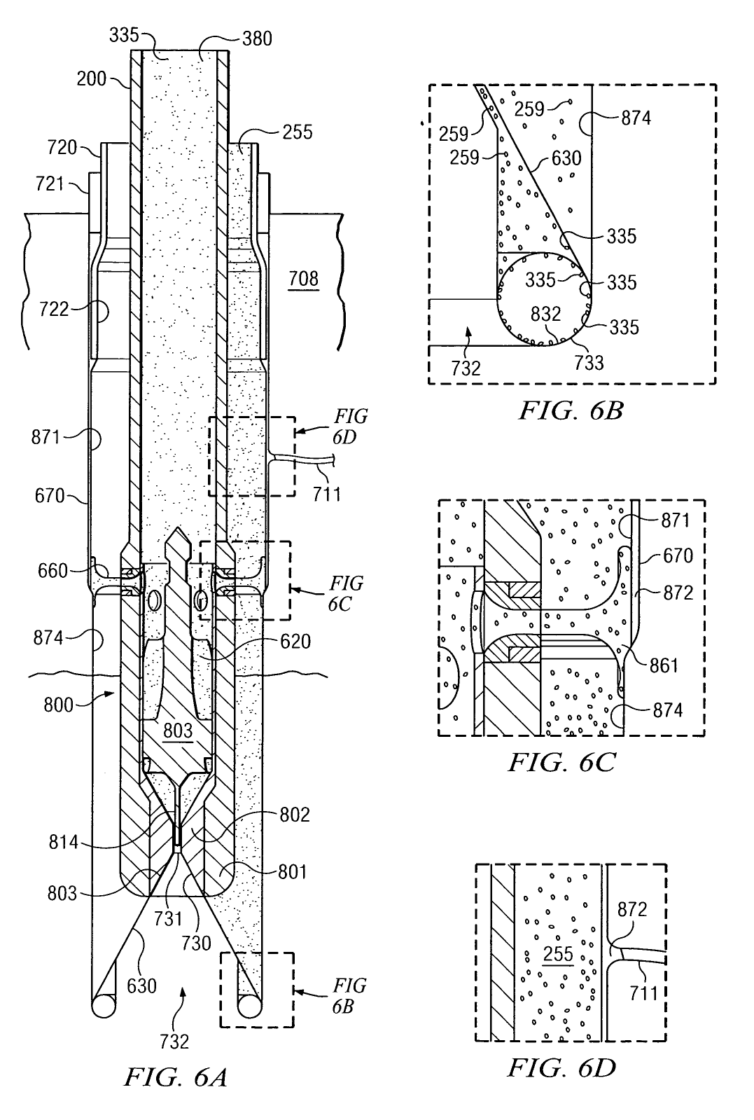

FIGS. 5 and 6 discuss, in greater detail, the structure and operation of a head assembly to be used in PJD. A full discussion of the apparatus can be found in U.S. Provisional Patent Application No. 60/930,403 of the herein named inventor entitled “Particle Jet Drilling Method and Apparatus,” filed May 16, 2007 and incorporated herein by reference.

FIG. 5a illustrates an isometric view of on embodiment of the jet head assembly 800. FIG. 6b illustrates an exploded view of the components of the jet head assembly 800 of the present invention. Jet head housing 801 houses stator housing 802 which houses stator 803. Stator 803 is formed with stator channels 620 running axially along the exterior surface of the stator. Swirling flow centralizer and stabilizer 814 extends from the distal end of stator 803. The stem of the stator 803 is built with a recessed profile 813 that allows a retrieval tool (not shown) to latch onto the stator assembly for removal. The stator 803 is permanently bonded to stator housing 802. Stator housing 802 is removably latched (latch not shown) the jet head housing 801. Typical Ports 804 and 805 are providing in stator housing 802 to allow fluid to circulate from the interior of the stator assembly through corresponding typical ports 806 and 807 in jet head housing 801. Nozzles 809 and nozzle retainer 808 are typical of the nozzles and retains for all radially spaced fluid ports typified by fluid ports 806 and 807 and are shown in their seated position in FIG. 5b.

FIG. 5c illustrates a cross-sectional view along section lines AA of FIG. 5d. Nozzles typified by nozzle 809 and nozzle retainer 808 are shown in place within jet head housing 801. Stator 803 and stator housing 802 are in place within jet head housing 801. Surfaces 814 and 810 form a first interior cavity for imparting a swirling motion to the fluid passing through this section of the stator assembly. Surfaces 812 and 814 form a second interior cylindrical swirl cavity for the stabilization of the swirling Slurry mass. The interior surface of the Stator Housing 802 forms an exit orifice 811 where the fluid passing through the cylindrical swirl stabilization chamber discharges through the exit orifice 811. The exit orifice 811 region provides a region where the centrifugal force of the swirling slurry mass is released in straight tangential lines forming an expanding conical jet form. FIG. 5e illustrates a side elevation the jet head 801 and drill pipe 200. FIG. 5f illustrates the end view of jet head 801. FIG. 5d illustrates end view of jet head 801 with section cutting line AA visible.

FIG. 6a illustrates a cross-section of lower section of a well bore showing one embodiment of well bore casing 720 cemented into formation 708 by cement sheath 721. Modified well bore wall surface 871 is shown next to unaffected formation 670 of formation 708. Well bore wall 874 is shown formed by the cutting action of cutting jet 630. Natural fracture 711 is shown adjacent modified well bore 871. A cross sectional view of a portion of the drill pipe 200 and the jet head assembly 800 is shown. Circulation of the pressurized drilling fluid 380 containing impactors 335 is shown flowing through the interior of drill pipe 200, through the stator vanes 620 where a swirling motion is imparted to the pressurized drilling fluid 380. The pressurized drilling fluid 380 is shown flowing through lower stator housing 802 and subsequently through exit orifice 811 of FIG. 5c. Within exit orifice 811 of FIG. 5c the pressurized drilling fluid 380 forms an expanding conical shaped cutting jet 630 which cutting action cuts formation 708 forming a bottom hole pattern 732. The cutting action of conical jet 630 cuts the formation face 730 generating formation cuttings 259 that are entrained in the drilling fluid for transportation up the annular space between the jet head body 802, the exterior drill pipe 200 and the well bore wall 874 and the interior wall 722 of casing 720 as a returning drilling fluid slurry 255. The return drilling fluid slurry 255 containing impactors and formation cuttings is shown in cross section flowing up only one side of the well bore annulus for clarity purposes.

FIG. 6b illustrates the effect of the action of the expanding conical cutting jet 630 flowing into a reentry toroidal shaped flow regime 832. Fluid jet 630 containing impactors 335 cuts the formation face 730 of FIG. 6d and carry the formation cuttings 259 into the reentry toroidal flow 832 where the drilling fluid, impactors 335 and formation cuttings 259 and 733 continue to cut the formation forming face 832. The formation cuttings 259 and impactors 335 circulate in the toroidal flow 832 continuing to cut the formation and are eventually forced out of the toroidal flow 832 to be circulated upwards within the well bore annulus to the drilling rig's surface equipment for processing.

FIG. 6c illustrates the circular shaped side jet 861 impacting well bore wall 874 where well bore wall 874 is modified by the jet action of impactors impacting the well bore wall. Modified well bore wall 871 forms a new well bore wall comprised of a thin layer of densified formation material 872. Formation region 670 is the unaffected near well bore region of formation 708.

FIG. 6d illustrates natural formation fracture 711 which has been sealed by the action of the side jets 861 and modified formation material 872 to isolate internal pathway of fracture 711 from the well bore and the drilling fluid 255 within well bore 708.

It should be particularly noted that FIGS. 5 and 6 have been taken, in the name, from above-referenced, prior filed U.S. Provisional Patent Application Ser. No. 60/930,403 filed May 16, 2007. In the 403 application, FIGS. 5 (a-e) and 6 (a-d) collate to FIGS. 5 (a-e), and 6 (a-d) with certain modifications made therein more specifically refer to the technology of the parent application as it is used in the present application.

The previous Detailed Description is of embodiment(s) of the invention. The scope of the invention should not necessarily be limited by this Description.

What is claimed is:

1. A method of storing greenhouse gasses in an underground, artificially created, secure, hydraulically isolated reservoir, the method comprising:
providing a drilling system for creation of a bore hole;
generating said bore hole utilizing said drilling system;
continuing the creation of said bore hole into a rock formation, said rock formation located at a shallowest depth necessary to achieve a combination of temperature and pressure sufficient to create a hydraulically sealed reservoir;
creating an artificial reservoir within said rock formation capable of storing a greenhouse gas therein; and
storing said greenhouse gas in said artificially created reservoir.

2. The method as set forth in claim 1, wherein said drilling system comprises rotary mechanical drilling.

3. The method as set forth in claim 1, wherein said drilling system comprises a non-rotary mechanical drilling system.

4. The method of claim 3, wherein said non-rotary mechanical drilling system comprise a particle jet drilling system.

5. The method of claim 3, wherein said non-rotary mechanical drilling system comprises a pulse laser drilling system.

6. The method as set forth in claim 3, wherein said non-rotary mechanical drilling system comprises a thermal spallation system.

7. The method as set forth in claim 1, wherein creating said artificial reservoir comprises hydraulically fracturing said rock formations, said rock formations having a plurality of existing joints.

8. The method as set forth in claim 14, wherein hydraulically fracturing said rock formations comprises dilating said existing joints with a fluid.

9. The method as set forth in claim 1, wherein storing said greenhouse gas comprises:
injecting said greenhouse gas into said reservoir;
plugging said bore hole; and
attaching a well head cap to a proximal end of said bore hole.

10. The method as set forth in claim 9, wherein plugging said bore hole comprises inserting a drillable, permanent bridge plug into said bore hole

11. The method as set forth in claim 9, wherein plugging said bore hole comprises placing a column of cement within said bore hole.

12. The method as set forth in claim 9, and further comprising the step of retrieving said greenhouse gas for subsequent use.

13. The method as set forth in claim 1, wherein said greenhouse gas is CO₂.

14. The method as set forth in claim 1, wherein said rock formation comprises a temperature of 250° C.

15. The method as set forth in claim 1, wherein said rock formation comprises a temperature of 300° C.

16. The method as set forth in claim 1, wherein said rock formation comprises a temperature of 500° C. and above.

17. A system for storing a greenhouse gas in an underground, artificially created, secure, hydraulically isolated reservoir, the system comprising:
a device adapted for capturing said greenhouse gas.
a reservoir disposed within a plurality of rock formations, said rock formations located at the shallowest depth necessary to achieve a combination of temperature and pressure sufficient to ensure said reservoir is hydraulically sealed;
a well, said well having a distal end fluidly coupled to said reservoir, and a proximal end having an injector head attached thereto; and
a pipe fluidly coupling said device adapted for capturing said greenhouse gas, and said injector head.

18. The system as set forth in claim 17, wherein said greenhouse gas is CO₂.

19. The system as set forth in claim 17, wherein said well is created using a rotary mechanical drilling system.

20. The system as set forth in claim 17, wherein said well is created using a non-rotary mechanical drilling system.

21. The system as set forth in claim 20, wherein said non-rotary mechanical drilling system comprise a particle jet drilling system.

22. The system as set forth in claim 21, wherein said particle jet drilling system further comprises a drilling head assembly, said drilling head assembly comprising:
a jet head housing;
a stator housing removably disposed within said jet head housing; and
a stator disposed within, and rigidly connected to, said stator housing, said stator comprising a plurality of stator channels disposed axially on a surface of said stator.

23. The system of claim 21, wherein said non-rotary mechanical drilling system comprises a pulse laser drilling system.

24. The system as set forth in claim 21, wherein said non-rotary mechanical drilling system comprises a thermal spallation system.

25. The system as set forth in claim 17, wherein creating said artificial reservoir comprises hydraulically fracturing said rock formations, said rock formations having a plurality of existing joints.

26. The system as set forth in claim 25, wherein hydraulically fracturing said rock formations comprises dilating said existing joints with a fluid.

27. The system as set forth in claim 17, wherein storing said greenhouse gas comprises:
injecting said greenhouse gas into said reservoir;
plugging said bore hole; and
attaching a well head cap to a proximal end of said bore hole.

28. The system as set forth in claim 27, wherein plugging said bore hole comprises inserting a drillable, permanent bridge plug into said bore hole

29. The system as set forth in claim 27, wherein plugging said bore hole comprises placing a column of cement within said bore hole.

30. A method of storing a greenhouse gas in a secure hydraulically isolated reservoir, the method comprising the steps of:
locating a subterranean rock formation appropriate for the storage of said greenhouse gas, said formation located at a shallowest depth necessary to achieve a combination of temperature and pressure sufficient to create a hydraulically sealed artificial reservoir;
creating a well bore, said well bore terminating in said rock formation;
creating said artificial reservoir within said rock formation; and
injecting said greenhouse gas into said artificial reservoir.

31. The method as set forth in claim 30, wherein creating said well bore comprises rotary mechanical drilling.

32. The method as set forth in claim 30, wherein creating said well bore comprises a non-rotary mechanical drilling system.

33. The method of claim 32, wherein said non-rotary mechanical drilling system comprise a particle jet drilling system.

34. The method as set forth in claim 32, wherein said non-rotary mechanical drilling system comprises a thermal spallation system.

35. The method as set forth in claim 30, wherein creating said artificial reservoir comprises hydraulically fracturing said rock formations, said rock formations having a plurality of existing joints.

36. The method as set forth in claim 35, wherein hydraulically fracturing said rock formations comprises dilating said existing joints with a fluid.

37. The method as set forth in claim 30, wherein storing said greenhouse gas comprises:
injecting said greenhouse gas into said reservoir;
plugging said bore hole; and
attaching a well head cap to a proximal end of said bore hole.

38. The method as set forth in claim 37, wherein plugging said bore hole comprises inserting a drillable, permanent bridge plug into said bore hole

39. The method as set forth in claim 37, wherein plugging said bore hole comprises placing a column of cement within said bore hole.

40. The method as set forth in claim 37, and further comprising the step of retrieving said greenhouse gas for subsequent use.

41. The method as set forth in claim 37, wherein said greenhouse gas is CO₂.

42. A method of forming a secure, hydraulically isolated reservoir, the method comprising:
forming a well bore;
forming an internal reservoir at a shallowest depth necessary to achieve a combination of temperature and pressure sufficient to hydraulically seal said internal reservoir, said internal reservoir in fluid communication with said well bore;
injecting a gas into said internal reservoir via said well bore; and
plugging said well bore in a manner ensuring integrity of said internal reservoir.

43. The method as set forth in claim 42, wherein forming said well bore comprises a rotary mechanical drilling system.

44. The method as set forth in claim 42, wherein forming said well bore comprises a non-rotary mechanical drilling system.

45. The method as set forth in claim 44, wherein said non-rotary mechanical drilling system comprises a particle jet drilling system.

46. The method of claim 44, wherein said non-rotary mechanical drilling system comprises a pulse laser drilling system.

47. The method as set forth in claim 44, wherein said non-rotary mechanical drilling system comprises a thermal spallation system.

48. The method as set forth in claim 42, wherein creating said artificial reservoir comprises hydraulically fracturing said rock formations, said rock formations having a plurality of existing joints.

49. The method as set forth in claim 48, wherein hydraulically fracturing said rock formations comprises dilating said existing joints with a fluid.

50. The method as set forth in claim 42, wherein said gas is a greenhouse gas.

51. The method as set forth in claim 42, wherein said gas is CO₂.

52. The method as set forth in claim 42, wherein injecting said gas comprises injecting said gas with a high pressure pump.

53. The method as set forth in claim 42, wherein plugging said bore hole comprises inserting a drillable, permanent bridge plug into said bore hole

54. The method as set forth in claim 42, wherein plugging said bore hole comprises placing a column of cement within said bore hole.

55. The method as set forth in claim 42, and further comprising the step of retrieving said greenhouse gas for subsequent use.
